(19) United States
(12) Patent Application Publication
(10) Pub. No.: US 2007/0210793 A1
(43) Pub. Date: Sep. 13, 2007

(54) METHOD AND MULTI-RECEPTION COIL MR APPARATUS FOR GENERATING AN MR IMAGE USING DATA FROM SELECTED COILS

(76) Inventor: Berthold Kiefer, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/676,654

(22) Filed: Feb. 20, 2007

(30) Foreign Application Priority Data
Feb. 20, 2006 (DE) 10 2006 007 769.5

(51) Int. Cl. G01V 3/00

(52) U.S. Cl. 324/307; 324/309; 324/318

(57) ABSTRACT

In a method for generation of magnetic resonance exposures of an examination subject using a magnetic resonance system with multiple coil elements for acquisition of imaging magnetic resonance signals, magnetic resonance signals for the magnetic resonance exposures to be generated are initially measured with at least one group of the available coil elements. An automatic pre-evaluation of the magnetic resonance signals respectively acquired from the individual coil elements then ensues. One or more of the coil elements are selected on the basis of results of the pre-evaluation and the generation of the magnetic resonance exposures ensues exclusively on the basis of the magnetic resonance signals that were acquired by the selected coil elements. A corresponding control device for a magnetic resonance system for generation of magnetic resonance exposures, and a computer program product, operate according to the method.

### BACKGROUND OF THE INVENTION

1. Field of the Invention

The present invention concerns a method for generation of magnetic resonance exposures of an examination subject by means of a magnetic resonance examination system in which a number of coil elements are available for acquisition of magnetic resonance signals, the coil elements being positioned at various locations relative to the examination subject. The invention also concerns a control device for a magnetic resonance system in order to generate magnetic resonance exposures of an examination subject according to such a method as well as a magnetic resonance system with such a control device and a computer program product which can be loaded into a memory of a corresponding programmable control device for implementation of the method.

2. Description of the Prior Art

Modern magnetic resonance system normally operate with a number of different antennas (often also called “coils”) for emission of radio-frequency pulses for nuclear magnetic resonance excitation and/or for acquisition of the induced magnetic resonance signals. A magnetic resonance system normally has one larger whole-body coil permanently installed in the apparatus. The whole-body coil is often arranged cylindrically around the patient acceptance chamber (for example with a structure known as a birdcage structure) in which the patient is supported on the patient positioning table during the data acquisition. Furthermore, one or more small local coils or, respectively, surface coils are frequently used in such a tomography apparatus. These local coils serve to acquire detailed images of body parts or organs of a patient that are located relatively near to the body surface. For this purpose the local coils are applied directly at a point on the patient at which the region to be examined is located. Given the use of such a local coil, RF radiation is in many cases effected with the whole-body coil (as a transmission coil) and the induced magnetic resonance signals are acquired with the local coils (as reception coils). In more extensive examinations, a number of coil arrays, which respectively in turn have multiple coil elements, are placed on and/or under the patient. The coil elements thereby form individual small antennas. Therefore, in the following the term “coil elements” is generally used, this term encompassing all types of antennas or coils regardless of whether they are individual antennas or elements of a connected coil array. In modern magnetic resonance systems all coil elements are simultaneously connected with the system and can thus be read out in parallel. For example, in a system is known as a TIM system (TIM=Total Imaging Matrix) from the company Siemens, the patient can be covered from top to bottom with coil arrays, with all coil elements being connected with the system.

For the generation of good-quality magnetic resonance exposures, for a data acquisition it is important to select, from among the multiple of coil elements present in the apparatus, those coil elements that are particularly suitable for a specific measurement of a specific acquisition region, i.e. for example a specific slice or a slice stack or volume within the measurement subject. This has previously ensued manually by input of suitable selection commands at a control terminal of the magnetic resonance system. The operator makes his or her selection according to whether the appertaining coil element is located in a suitable position with regard to the region to be acquired in the subsequent measurement and whether the appertaining coil element exhibits a matching exposure region, i.e. whether the region of interest can be measured at all with this coil element.

The position of the appertaining coil element is specified in part at the manufacturing site for coil elements with a fixed position with regard to the patient positioning table. This position is then “known” to the magnetic resonance system, i.e. in the control device of the magnetic resonance system, even if this coil element can normally be displaced within a small region. Alternatively, the position can be measured before the magnetic resonance measurement. Often only the position in the z-direction (i.e. in the longitudinal direction of the patient positioning table) is measured. The coordinates perpendicular to that direction are unknown and (for some manufacturers) are estimated at the factory at an expected average. An exposure region can likewise be specified at the factory for each coil element. This, however, is merely an estimated exposure region to be expected on average. In particular it is hereby not considered whether this region is even actually filled by a load in a data acquisition or whether the exposure region has a quite different shape than that specified (for example a rectangular shape).

The correct selection of the coil elements thus requires a significant degree of knowledge and experience on the part of the operator, particularly since the available information specified at the factory about positions and exposure regions of the coil elements are in practice often not sufficiently precise and do not take into account the real conditions for the concrete measurement. The selection method is therefore quite error-prone, primarily given a number of coil elements that are freely positioned on the patient. if the optimal coil elements or the optimal coil element combination are/is not selected for a subsequent measurement, the quality of the subsequent exposures is inevitably degraded. This can possibly lead to the situation that data acquisitions must be repeated, which extends the total acquisition time. This not only reduces the efficiency of the magnetic resonance system and of the operating personnel, but also leads to a higher exposure of the patient.

A method for generation of magnetic resonance exposures is described in DE 10 2004 026 996 A1, in which a radio-frequency signal is initially emitted in a pre-measurement before the actual magnetic resonance measurement and a three-dimensional exposure profile (known as a magnitude map) is measured with the coils that are available for selection for the planned magnetic resonance measurement. The magnitude measurements required for the implementation of the invention in fact can be conducted relatively quickly. In order to require no additional measurement time, this pre-measurement can also be combined with pre-measurements for other application purposes. Nevertheless, it is ultimately necessary to implement corresponding pre-measurements having a time requirement associated therewith. This can be disadvantageous given a selection of coils for a planned magnetic resonance measurement for which the image data should be acquired during a movement of the patient table, since the position of the coils changes from acquisition to acquisition relative to the magnetic resonance tomography apparatus.

### SUMMARY OF THE INVENTION

An object of the present invention is to provide an optimized, very fast method for generation of magnetic resonance exposures in a magnetic resonance system with a number of coil elements as well as a corresponding control device for such a magnetic resonance system, with which the aforementioned disadvantages described previously are avoided.

The above is achieved in accordance with the invention by a method for generation of magnetic resonance exposures of an examination subject using a magnetic resonance system with multiple coil elements for acquisition of imaging magnetic resonance signals, wherein magnetic resonance signals for the magnetic resonance exposures to be generated are initially measured with at least one group of the available coil elements. An automatic pre-evaluation of the magnetic resonance signals respectively acquired from the individual coil elements then ensues. One or more of the coil elements are selected on the basis of results of the pre-evaluation and the generation of the magnetic resonance exposures ensues exclusively on the basis of the magnetic resonance signals that were acquired by the selected coil elements. A corresponding control device for a magnetic resonance system for generation of magnetic resonance exposures, and a computer program product, operate according to the method.

In the inventive method the induced magnetic resonance signals are measured (detected) with at least one group of the available coil elements (i.e. with multiple coil elements) for the magnetic resonance exposures to be generated. This “candidate group” that is used for the measurement can in principle include all coil elements that are actually available. Alternatively, a rough pre-selection can also be made, meaning that, for example, a group of coil elements is sought that is roughly located in the region of the exposures to be produced. For example, for a system in which the patient is completely covered with coils and an exposure in the torso region is produced, all coil elements located in the region of the torso and back are selected; only the coils located on and below the legs are not used for this measurement.

According to the invention, an automatic pre-evaluation of the acquired magnetic resonance signals ensues for the magnetic resonance exposure to be generated. The actual selection of one or more coil elements then ensues on the basis of results of this pre-evaluation. The magnetic resonance exposures are thereupon generated exclusively on the basis of the magnetic resonance signals that were acquired by the selected coil elements. This means that in the inventive method only the signals that were measured by the individual coils are selected, based on whether they can reasonably contribute at all to the acquisition. Only when this is the case are they considered in the reconstruction of the images; otherwise they are discarded.

In this method an exact manual or automatic selection of the coils before the planned magnetic resonance measurement is consequently no longer necessary. At most a rough pre-selection can optionally be made as described to accelerate the method. Such a rough pre-selection can be implemented without problems by untrained operators. The same optimal result is achieved even when no such pre-selection ensues, i.e. when the measurement is implemented with all coils.

A control device in accordance with the invention for a magnetic resonance system, that has multiple coil elements for acquisition of imaging magnetic resonance signals for generation of magnetic resonance exposures of an examination subject, has a pre-evaluation unit in addition to a signal readout unit designed to read out the imaging magnetic resonance signals in parallel, at least from a group of the available coil elements, as well as in addition to all further typical components of such a control device. The pre-evaluation unit subjects the magnetic resonance signals respectively acquired by the individual coil elements for the magnetic resonance exposures to be generated to a pre-evaluation. Moreover, the control device has a selection unit that selects one or more of the coil elements on the basis of results of the pre-evaluation. Moreover, an image reconstruction unit must be equipped such that the magnetic resonance exposures are generated exclusively on the basis of the magnetic resonance signals acquired by the selected coil elements. This means that the entire control device is fashioned such that, with the aid of the pre-evaluation unit and the selection unit, the magnetic resonance signals are initially analyzed as to the extent they can contribute at all to an image to be produced. Signals from coil elements that do not contribute to the signal for the selected slices in which images should be generated can be immediately discarded. A very fast generation of magnetic resonance exposures with good quality is thus possible without a prior manual selection by an operator being necessary.

Not only is the workflow accelerated by the invention, but the work results are also improved.

A corresponding control device can be used in arbitrary magnetic resonance systems, i.e. in conventional magnetic resonance tomography systems or in magnetic resonance spectroscopy systems.

The inventive components of the control device, in particular the pre-evaluation unit, the selection unit and the image reconstruction unit, can also be realized in the form of software in a programmable control device for magnetic resonance systems. This has the advantage that control devices that are already present can also be upgraded (retrofitted) without problems by software updates.

As already mentioned, a pre-selection of a “candidate group” of coil elements with which the measurement of the magnetic resonance signals is implemented is not absolutely necessary. Nevertheless, in a preferred system the possibility is provided to make such a pre-selection. This can ensue such that the group of the available coil elements that is used for acquisition of the magnetic resonance signals includes all those available coil elements that are associated with a defined spatial viewing region (known as the “Field of View” (FOV)) corresponding to the magnetic resonance exposures to be generated. For example, for data acquisition in the head region, all head and neck coils are selected, or for data acquisition for spinal column exposures the coil elements are selected that are located in a wide region around the desired acquisition slice of the spinal column, for example all spinal column coils.

The method is thereby accelerated somewhat more since an analysis of magnetic resonance signals of coils which can definitely not contribute to the exposure (for example an analysis of coils in the leg region in the case of a head acquisition) is not necessary for the pre-evaluation.

There are various possibilities for implementation of the pre-evaluation.

In a preferred version a signal value is determined in a defined manner for each individual coil element, and all of the coil elements are selected that have a signal value greater than or equal to a predetermined threshold value.

In a preferred embodiment this threshold is predetermined in a fixed manner, independent of the respective measurement to be implemented. In an alternative preferred embodiment the threshold is individually determined for each measurement, meaning that (for example) the signal values are determined for all coil elements and the threshold is then selected as a fraction of the maximum signal value measured in the measurement. This has the advantage that the measured magnetic resonance signals from at least one of the coil elements are automatically used for generation of the magnetic resonance exposure, even given weaker signals to be acquired. The establishment of a fixed threshold, however, ensures that exposures are generated only when at least one specific minimum signal value signal is reached and significant exposures can be generated at all. The pre-evaluation or a selection of coil elements can then already additionally ensue while the signal values are determined, or magnetic resonance signals are acquired, for other coil elements. This means that the selection method is then faster.

A combination of a fixed threshold (i.e. an absolute minimum value) and a variable threshold (which is a relative proportion of the maximum measured intensity value) can alternatively be used.

In a preferred embodiment a signal maximum measured with the appertaining coil element is simply determined as a signal value which is compared with the predetermined threshold. This means that it is established which maximum signal intensity the respective coil element has measured and this intensity is used as a signal value of the appertaining coil element for the selection.

In an alternative preferred exemplary embodiment, the signal value of a coil element is generated on the basis of an integration over a measured signal determined with the appertaining coil element. This means, for example, that the measured signal is spatially integrated in the case of a spatially-resolved measurement with the appertaining coil element.

In a preferred variant of the invention the selection of the coil elements ensues directly on the basis of the measured raw data. A simple analysis of the raw data is the evaluation of an echo maximum in which the echo signals of the coil elements whose echo maximum lies below an established threshold are immediately discarded. This variant is extraordinarily fast.

In an alternative variant, in the pre-evaluation image data are already reconstructed on the basis of the magnetic resonance signals and the coil elements are then selected using the reconstructed image signals. For example, in the pre-evaluation, images can already be reconstructed that reflect what the individual coil elements respectively “see”. The coil election (or selection of the signals) then ensues on the basis of the analysis of these “pre-evaluation images” and the signals of the selected coil elements are ultimately combined for generation of the desired exposures. This method is particularly reasonable when the signal value should ensue by a spatial integration over the signals measured with the respective coil element.

In order to achieve a data reduction as quickly as possible, during the acquisition of the magnetic resonance signals (i.e. during the data acquisition) already-acquired signals can already be pre-evaluated and the signals of all coil elements that do not contribute to the signal for the selected slices are again discarded.

The described inventive method can be advantageously used in applications in which the data are acquired during a movement of the patient table. Such methods are known as “Move-During-Scan methods” (MDS methods). The signals of the suitable coil elements are evaluated dependent on the immediately current table position and the correct coil elements are thus selected dependent on the current table position. The method is furthermore particularly suitable for parallel imaging methods. Such parallel imaging methods are also generally known to those skilled in the art as “PAT methods” (PAT=Parallel Acquisition Technique).

Overall, the inventive method ensures (even without elaborate manual selection by the operator) that, dependent on the respective table position and given a parallel imaging, only the signals of the coil elements will be utilized for the reconstruction whose acquisition sensitivity lies in the region of the current positioned slices and which are required for the reconstruction of the magnetic resonance images (in particular given parallel imaging), in order to achieve an optimal result.

### DESCRIPTION OF THE DRAWINGS

FIG. 1 is a perspective VIEW of a patient who is covered from head to toe with acquisition coil elements.

FIG. 2 is a view of a typical graphical user interface of a “coil selection platform” of a conventional control device,

FIG. 3 is a flowchart of a preferred embodiment of the inventive method.

FIG. 4 is a graphical representation of the position of a transverse slice to be acquired in the head region of a patient as well as the position of the “candidate group” of coil elements pre-selected for this.

FIG. 5 is a graphical representation of the raw data of the individual coil elements acquired in the time domain with a measurement arrangement according to FIG. 4,

FIG. 6 shows images reconstructed in the frequency domain from the signals of the individual coil elements from FIG. 5.

FIG. 7 is a graphical representation of the position of a transverse slice to be acquired in the spinal column region of a patient as well as the position of the “candidate group” of coil elements pre-selected for this.

FIG. 8 shows images reconstructed in the frequency domain from the signals of individual coil elements with a measurement arrangement according to FIG. 7.

FIG. 9 is a table that shows the echo signal strength form a measurement of a transverse slice SHE in the head region according to FIGS. 4 through 6, and in comparison to this, form a measurement of a transversal slice S_{SP} in the spinal column region according to FIGS. 7 and 8,

FIG. 10 is a schematic representation of an exemplary embodiment of an inventive magnetic resonance system.

### DESCRIPTION OF THE PREFERRED EMBODIMENTS

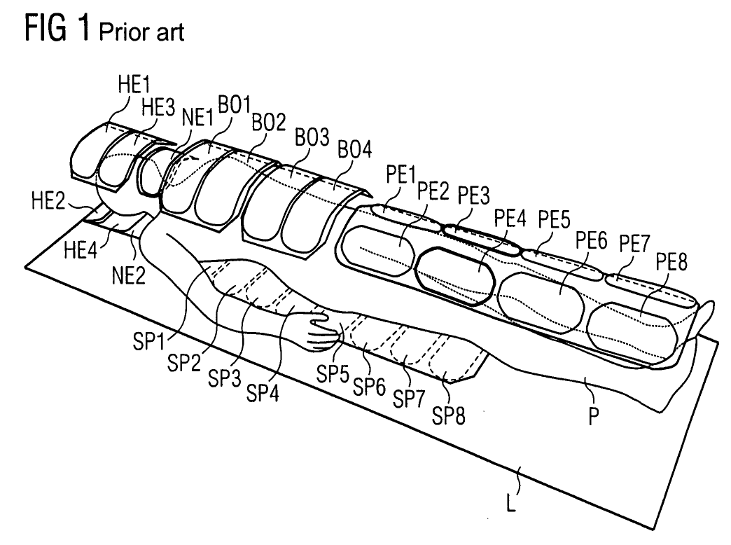

FIG. 1 shows a patient P positioned on a recumbent bed L covered with local coil arrays from head to toe for implementation of a data acquisition with TIM technology. The local coil array is located both below and on the patient P. In the shown exemplary embodiment, two local coil elements HE1, HE 3 are located on the head of the patient P and two further local coil elements HE2, HE 4 are located below the head, which local coil elements serve for head acquisitions. A first coil element NE1 is located in the neck region (neck) on the patient P and a second coil element NE2 is located below the neck of the patient P. The patient's back lies on a spinal column coil array (spine matrix coil) with in total eight coil elements SP1, SP2, SP3, SP4, SP5, SP6, SP7, SP8. Two further coil arrays (body matrix coil) which respectively have two coil elements BO1, BO2, BO3, BO4 are located on the breast and stomach region of the patient P. A further coil array (Peripheral Angiography Matrix Coil) with in total eight coil elements PE1, PE2, PE3, PE4, PE5, PE6, PE7, PE8 are placed on the upper and lower legs of the patient P.

All coil elements HE1, . . . , HE4, NE1, NE2, SP1, . . . , SP8, BO1, . . . , BO4, PE1, . . . , PE8 are simultaneously connected to the readout unit of the magnetic resonance system. This is possible without further measures since the present systems comprise readout units with a correspondingly large number of acquisition channels. Systems equipped with 32 acquisition channels are commercially available. Systems presently in the experimental phase already even have 96 acquisition channels and more. All coil elements HE1, . . . , HE4, NE1, NE2, SP1, . . . , SP8, BO1, . . . , BO4, PE1, . . . , PE8 can be read out in parallel by the magnetic resonance system via these acquisition channels.

According to the conventional methods, the implementation of a magnetic resonance measurement it is required that the operator manually select in advance the coils used for the respective measurement. A graphical user interface of what is known as a “coil selection platform” as it is shown in illustration 2 is available to him for this. In the example shown in illustration 2, only the head coil elements HE1, HE2, HE3, HE4, the neck coils NE1, NE2 and the spinal column array with the coils SP1, . . . , SP8 are connected to the magnetic resonance system. By clicking on the correspondingly designated “buttons” for the individual coil elements HE1, . . . , HE4, NE1, NE2, SP1, . . . , SP8, with an optical pointing device (for example by a mouse double click), the operator can precisely determine which of the displayed coil elements are used for a subsequent measurement. As already described in the preceding, the operator must thereby optimally precisely select the coils dependent on the current exposure to be produced (i.e. the slice position at which the exposure should be produced) in order to acquire an optimally good image. This is no longer required with the inventive method.

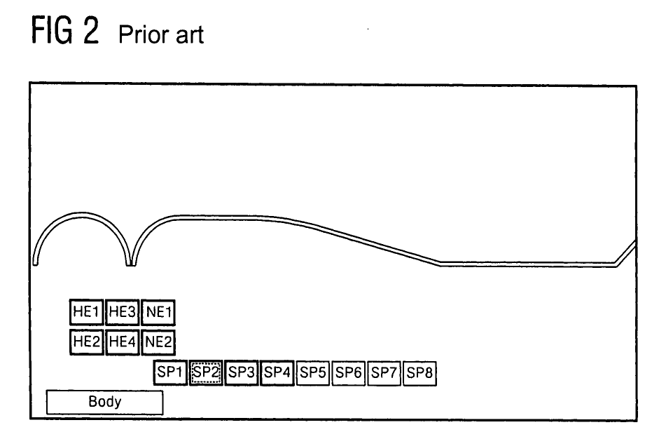

In the inventive method the user can additionally use the coil selection platform at most in order to select a specific candidate group of coil elements before the measurement or, respectively, in order to exclude specific coil elements which definitively are not considered for the subsequent measurement in advance. For example, for acquisitions in the head region and in the upper chest region the operator can exclude the coil elements SP5, SP6, SP7, SP8 in the lower spinal column region of the patient P from the measurement. As shown in FIG. 2, for this purpose the operator has simply selected the head coil elements HE1, HE2, HE3, HE4, the neck coil elements NE1, NE2 and the upper coil elements SP1, SP2, SP3, SP4 of the spinal column array via corresponding clicks. A knowledge of exactly where the slice to be acquired is situated and which coils are in the position to contribute to the measurement of such an exposure is not necessary.

At this point it should be noted again that the pre-selection of a coil element candidate group is purely optional and that in principle the user can also select all coils or, respectively, that such a coil selection platform as it is shown in FIG. 2 can also be foregone and the measurements are then always implemented with all coils.

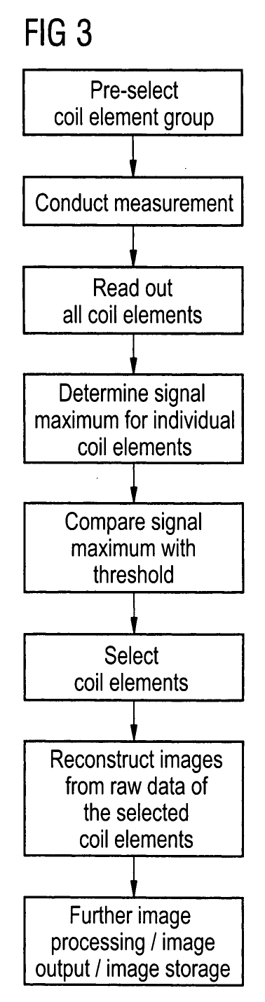

The inventive measurement workflows are explained in the following using the exemplary embodiments shown in FIGS. 3 through 9:

FIG. 3 shows a flowchart for an embodiment of the method. After the operator has made a pre-selection of the coil element group in step I (as this is shown in FIG. 2) the measurement is implemented in step II with all coil elements of this candidate group.

All coil elements are then read out in step III. A signal maximum, for example the maximum echo signal which was measured with the respective appertaining coil elements, is subsequently determined in a step IV for each of the coil elements. The signal maxima are then respectively compared with a fixed threshold (step V) and in step V1 the coil elements are accordingly selected for which the signal maximum lay above the threshold.

Alternatively, instead of the signal maximum a different suitable signal value can also be determined in order to use this for selection of the coil elements.

In step VII the desired images are subsequently reconstructed from the raw data of the selected coil elements. A further image processing and/or an image output and/or an image storage ensue/s in a typical manner in step VIII.

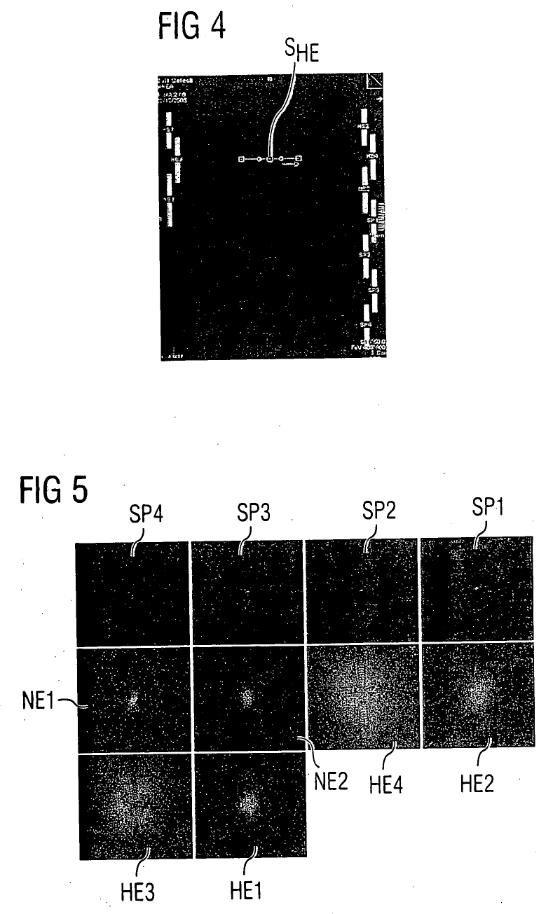

The pre-processing and selection procedure of this method is additionally clarified using FIGS. 4, 5, 6 and 9 using a concrete example, namely a measurement of a transversal acquisition slice SHE in the head region.

FIG. 4 shows the position of the slice SHE to be measured relative to the coil elements HE1, HE2, HE3, HE4, NE1, NE2, SP2, SP3, SP4 pre-selected according to FIG. 2. As is clearly to be seen, the transversal slice SHE in which the exposure should be generated is located between the coil elements HE3 and HE4.

FIG. 5 shows the measured raw data of the individual coil elements HE1, HE2, HE3, HE4, NE1, NE2, SP1, SP2, SP3, SP4 in the time domain. Here it is clearly shown that the strongest signal is acquired from the head coil elements HE4 and HE3, and moreover a strong signal is also acquired from the head coil elements HE2, HE2 [sic] and from the neck coil elements NE1, NE2.

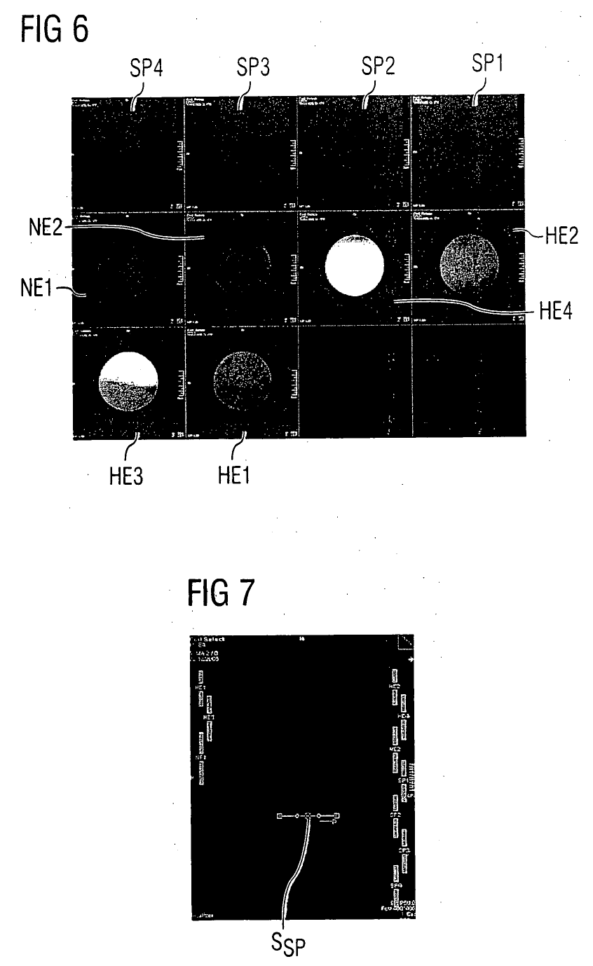

FIG. 6 shows the respective images reconstructed in frequency space from the raw data of the individual coil elements HE1, . . . , HE4, NE1, NE2, SP1, . . . , SP4 for the individual coil elements HE1, . . . , HE4, NE1, NE2, SP1, . . . , SP4. The arrangement of the images corresponds to that in FIG. 5. Here as well the image exposure clearly reflects the acquisition sensitivity of the individual coil elements HE1, . . . , HE4, NE1, NE2, SP1, . . . , SP4 in the region of the excited slice SHE.

In the table shown in FIG. 9 the echo signal strengths for the measurement configuration shown in FIG. 4 is numerically represented again in the second column. All echo signal strengths that are greater than a threshold of 150 are printed bold in the table. For this measurement a corresponding threshold of 150 can therefore be established in order to discard all echo signals of the coil elements that lie below the established threshold (here the signals of the coil elements SP1, SP4 of the spinal column array).

A second measurement example in which an exposure in a transversal acquisition slice S_{SP} should be produced in a spinal column position is shown in FIGS. 7, 8 and 9. Here as well the same coil element group is used as in the first example, i.e. the coil elements HE1, . . . , HE4, NE1, NE2, SP1, . . . , SP4 selected in illustration 2.

As can be seen in FIG. 7, the transversal slice S_{SP} within which the exposure should be produced lies directly above the spinal column coil element SP2.

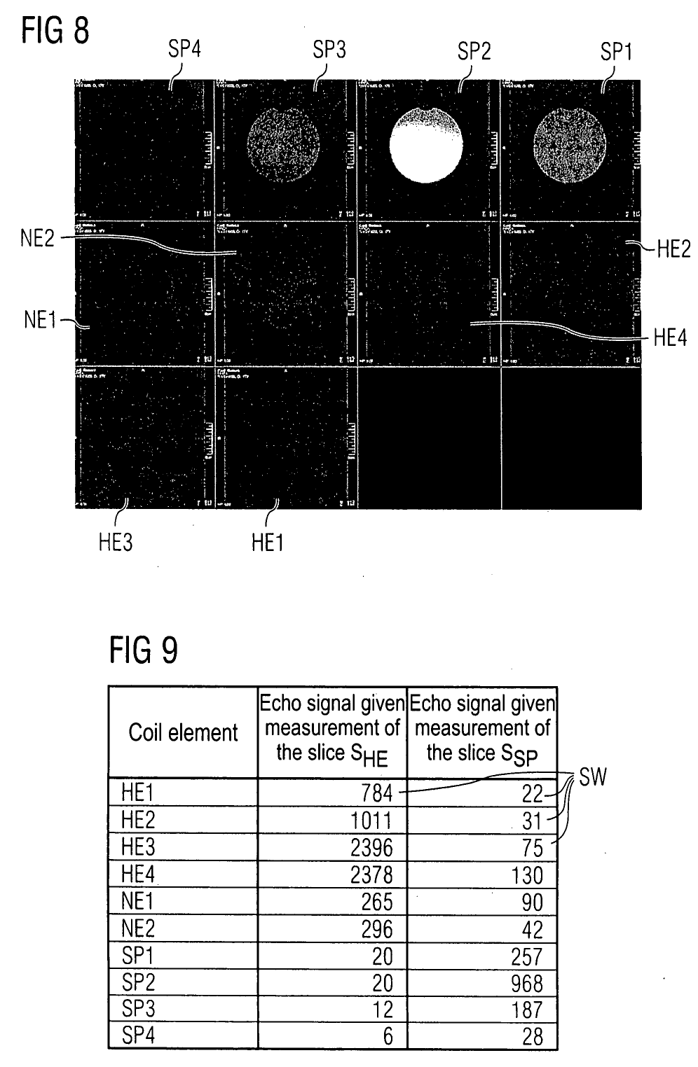

In addition to this, FIG. 8 already shows images reconstructed from the signals of the individual coil elements HE1, . . . , HE4, NE1, NE2, SP1, . . . , SP4. the arrangement of the images in frequency space is identical to that in FIGS. 5 and 6. Here it is clearly shown that the spinal column coil element SP2 is best exposed (as expected) and the spinal column coil elements SP1, SP3 moreover contribute to the image. The same image also results from the numerical representation in the right column of FIG. 9. Here only the values of the coil elements SP1, SP2, SP3 lie above the threshold of 150. All other coil elements HE1, HE2, HE3, HE4, NE1, NE2, SP4 show lower echo signals. Therefore only the coil elements SP1, SP2, SP3 would be automatically selected for this measurement.

The results show that it is possible to initially acquire with all available coil elements and to only select after the fact the relevant coil elements that significantly contribute to the signal. The signals of the other coil elements can then simply be discarded. The images likewise show that the selection of the relevant coil elements can alternatively ensue by analysis of the raw data or by an analysis of the reconstructed data, meaning that arbitrary evaluation modes can be constructed in order to automatically select specific coil elements on the basis of the pre-evaluation results. A particularly fast and simple analysis of the raw data thus exists in an evaluation of the echo maximum via comparison with an established threshold as this is shown in FIG. 9.

Such a threshold can be fixed, for example, by a pure “noise scan” (i.e. an acquisition without radio-frequency irradiation) is implemented beforehand. In this measurement each of the coils would then have to merely acquire the typical background (base) noise, such that a threshold can be very simply established on the basis of such a measurement.

More complicated selection mechanisms are likewise also possible (in particular given use of the already-reconstructed data) insofar as this is desired, such as, for example, a spatial integration of the signal instead of a pure evaluation of the simple signal maximum.

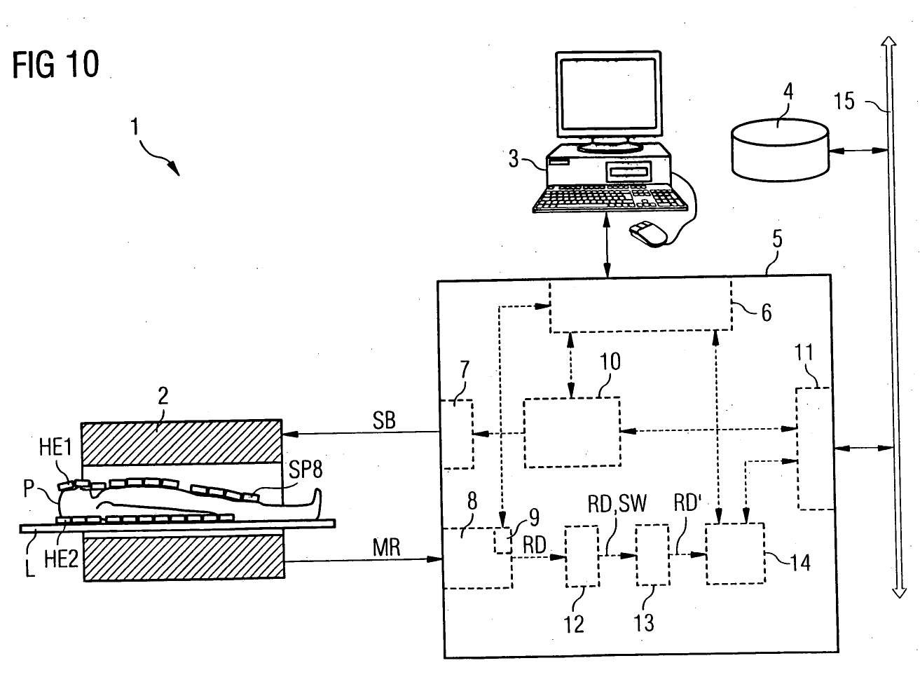

FIG. 10 shows an exemplary embodiment for a commercially-available magnetic resonance system 1 which, however, is additionally, correspondingly equipped in order to operate according to the inventive method. The core of this magnetic resonance system 1 is the magnetic resonance scanner 2 itself in which a patient P is positioned on the recumbent bed L in an annular basic field magnet that encloses the measurement space. A number of local coils HE1, HE2, . . . , SP8 are located on and below the patient, as this is shown in more detail in FIG. 1.

The recumbent bed L can be displaced along the longitudinal axis of the scanner 2. A whole-body coil (not shown) with which radio-frequency pulses can be emitted and acquired is located within the basic field magnet in the tomograph 2. Moreover, the scanner 2 has in a typical manner, gradient coils (not shown in FIG. 10) in order to be able to apply a magnetic field gradient in each spatial direction.

The scanner 2 is controlled by a control device 5 which is shown separately here. A terminal 3 is connected to the control device 5 via a terminal interface 6. This terminal 3 has a screen, a keyboard and, a pointer device for a graphical user interface, for example a mouse or the like. The terminal 3 serves as, among other things, a user interface via which an operator operates the control device 5 and therewith the scanner 2. Both the control device 5 and the terminal 3 can also be integral components of the scanner 2.

The control device 5 is connected via a bus interface 11 to a data bus 15 of a communication network such as, for example, an image information system or the like. For example, raw data and/or finished constructed images can be stored in an image data storage 4 or images can be sent to filming or finding stations (not shown) via this data bus 15. Patient data, comparison images or other data can likewise be received via this data bus 15.

The magnetic resonance system 1 can also have all further typical components or, respectively, features that are necessary or desirable for an operation of such a system 1. The necessary components and the precise functionality of typical magnetic resonance systems are known to those skilled in the art. Therefore these components are not shown in FIG. 10 for better clarity.

The connection of the control device 5 ensues via a control interface 7 through which the matching control commands SB are transmitted to the scanner 2. The magnetic resonance signals MR which are measured by the individual coil elements HE1, HE2, . . . , SP8 are read out by a readout unit 8. For this the readout unit 8 has a corresponding number of acquisition channels so that the coil elements HE1, HE2, . . . , SP8 can respectively be individually connected. This is shown only schematically by a signal path in FIG. 10.

In order to generate specific exposures, it is initiated by an activation unit 10 that the matching control commands SB are output to the individual components of the scanner 2 via the control interface 7 so that a measurement with a desired pulse sequence is implemented by the scanner 2. For this the radio-frequency pulses must be emitted in the correct order and the correct strength according to the specifications of the desired pulse sequence. At the same time the gradient pulses must be set at the desired strength in the matching chronological arrangement.

Such an activation typically ensues according to predetermined measurement protocols in which it is precisely defined which measurements are to be implemented with which pulse sequences. These can be stored in a storage unit (not shown) of the activation unit 10. The operator can communicate with the activation unit 10 via the terminal 3 and the interface 6 for selection of the matching protocols or, respectively, for definition of new protocols. Corresponding data or complete measurement protocols can likewise also be passed to the activation unit 10 via the bus interface 11 and the data bus 15.

As previously described, in a measurement the magnetic resonance signals MR measured by the coil elements HE1, HE2, . . . , SP8 are read out by the readout unit 8. A component of the readout unit is here a pre-selection unit 9 with which a group of coil elements can optionally be selected, with which group a subsequent measurement is implemented, i.e. whose acquired magnetic resonance signals are actually read out by the readout unit 8. The user can manually implement this pre-selection, which here is schematically represented by a connection between the terminal interface 6 and the pre-selection unit 9.

The raw data RD acquired by the readout unit 8 are then inventively passed to a pre-evaluation unit 12 which implements a pre-evaluation of the raw data RD, for example simply determines the signal maximum measured by the individual coil elements HE1, HE2, . . . , SP8 as a signal value SW. The coil elements whose measurement values should be used for an image reconstruction are then selected in a selection unit 13 on the basis of the results of the pre-evaluation. This means that the measured signals of all other non-selected coil elements are discarded.

The selected raw data RD′ (or, if applicable, image data already reconstructed beforehand in the pre-evaluation) are then passed to the actual image reconstruction unit 14 which reconstructs the desired images. The reconstructed images then can be sent via the terminal interface 6 to the terminal 3 for display on the screen of this terminal 3. Alternatively or additionally, the reconstructed images can also be stored in a image storage via the bus interface 11 and the data bus 15.

At this point it is noted that the readout unit 8, the pre-evaluation unit 12, the selection unit 13 and/or the image reconstruction unit 14 can also be fashioned as a common unit. These units 8, 12, 13, 14, like the other units or components of the magnetic resonance system 1, can likewise also be formed as sub-units.

The components required for realization of the invention in a magnetic resonance system 1, in particular the activation unit 10, the pre-evaluation device 12, the selection device 13 and the image reconstruction device 14, can be realized completely or to a predominant degree in the form of software components. Typical magnetic resonance systems have programmable control devices anyway, such that the invention can preferably be realized in this manner with the aid of suitable control software. This means that a corresponding computer program product is directly loaded into the memory of a programmable control device 5 of the appertaining magnetic resonance system 1 which comprises program code means in order to implement the inventive method. Already-existing magnetic resonance systems can also be upgraded simply and cost-effectively in this manner.

Some of the components can be realized as sub-routines in components that are already present in the control device 5 or that existing components can be used for the inventive purpose. The pre-evaluation device 12 or the selection device 13 can thus also be fashioned as a sub-module of an image reconstruction unit 14.

The method workflow described in detail in the preceding as well as the shown magnetic resonance system are only exemplary embodiments that can be modified in various manners by those skilled in the art without departing from the scope of the invention. Although the invention was described as an example of magnetic resonance systems in the medical field, the usage possibilities are not limited to this field. The invention can likewise also be used in scientific and/or industrial systems.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for generating a magnetic resonance exposure of an examination subject using a magnetic resonance system having a number of reception coil elements that respectively receive magnetic resonance imaging signals, said method comprising the steps of:
acquiring magnetic resonance signals for a magnetic resonance exposure using at least one group of available coils from among said number of coils;
automatically electronically evaluating the respective magnetic resonance signals received by the individual coil elements in said group;
selecting at least one coil element in said group dependent on said evaluation; and
generating said magnetic resonance exposure using only the respective magnetic resonance signals received by said at least one of said coil elements selected dependent on said evaluation.

2. A method as claimed in claim 1 wherein the step of evaluating the magnetic resonance signals respectively received by said coil elements in said group comprises determining a signal value in a predetermined manner from the magnetic resonance signal received by each of said coil elements in said group, and comparing each signal value to a threshold, and generating said magnetic resonance exposure using the respective magnetic resonance signals received by coil elements having a signal value that is greater than or equal to said threshold.

3. A method as claimed in claim 2 comprising receiving said magnetic resonance signals with said coil elements in said group in a magnetic resonance scan, and selecting said threshold dependent on an attribute of said scan.

4. A method as claimed in claim 2 comprising determining said signal value as a maximum of the magnetic resonance signal for each of said coil elements in said group.

5. A method as claimed in claim 2 comprising determining said signal value as an integration over the magnetic resonance signal for each of said coil elements in said group.

6. A method as claimed in claim 1 wherein said signals received by said coil elements in said group represent raw data, and wherein the step of selecting at least one of said coil elements comprises selecting at least one of said coil elements dependent on said raw data.

7. A method as claimed in claim 1 wherein said magnetic resonance signals respectively received by said coil elements in said group represent raw data, and wherein the step of selecting at least one of said coil elements comprises selecting said at least one of said coil elements dependent on image data reconstructed from said raw data.

8. A method as claimed in claim 1 comprising evaluating said magnetic resonance signals in a time span that at least partially overlaps a time span encompassing reception of said magnetic resonance signals by said coil elements in said group.

9. A method as claimed in claim 1 comprising using, as said group of available coil elements, all coil elements in said number of coil elements.

10. A method as claimed in claim 1 wherein said number of coil elements comprise multiple groups of coil elements respectively located, with respect to an examination subject, for acquiring magnetic resonance signals from different regions of the examination subject, and wherein said method comprises selecting a group of coil elements, from among said multiple groups of coil elements, for receiving said magnetic resonance signals that is located to receive magnetic resonance signals from a region of the examination subject to be shown in said magnetic resonance exposure.

11. A control device for obtaining a magnetic resonance exposure of an examination subject by operating a magnetic resonance system having a number of reception coil elements that respectively receive magnetic resonance imaging signals, said control device operating said magnetic resonance apparatus to acquire magnetic resonance signals for a magnetic resonance exposure using at least one group of available coils from among said number of coils, and automatically electronically evaluating the respective magnetic resonance signals received by the individual coil elements in said group, and selecting at least one coil element in said group dependent on said evaluation, and generating said magnetic resonance exposure using only the respective magnetic resonance signals received by said at least one of said coil elements selected dependent on said evaluation.

12. A magnetic resonance system comprising,
a plurality of reception coil elements that respectively receive magnetic resonance imaging signals from a subject;
a data acquisition unit that acquires magnetic resonance signals from a subject for a magnetic resonance exposure using at least one group of available coils from among said number of coils; and
a processor that automatically electronically evaluates the respective magnetic resonance signals received by the individual coil elements in said group, and selects at least one coil element in said group dependent on said evaluation, and generates said magnetic resonance exposure using only the respective magnetic resonance signals received by said at least one of said coil elements selected dependent on said evaluation.

13. A computer-readable medium encoded with a data structure for generating a magnetic resonance exposure of an examination subject using a magnetic resonance system having data acquisition unit with a plurality of reception coil elements that respectively receive magnetic resonance imaging signals, and said data structure causing said process to:
operate said data acquisition unit to acquire magnetic resonance signals for a magnetic resonance exposure using at least one group of available coils from among said number of coils;
automatically electronically evaluate the respective magnetic resonance signals received by the individual coil elements in said group;
select at least one coil element in said group dependent on said evaluation; and
generate said magnetic resonance exposure using only the respective magnetic resonance signals received by said at least one of said coil elements selected dependent on said evaluation.
